(19) United States
(12) Patent Application Publication
(10) Pub. No.: US 2006/0135890 A1
(43) Pub. Date: Jun. 22, 2006

(54) Adjustable goggle for eye massagers

(76) Inventor: Mali Tsai, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/097,298

(22) Filed: Apr. 4, 2005

(30) Foreign Application Priority Data
Dec. 21, 2004 (TW) 093220577

(51) Int. Cl. A61H 5/00

(52) U.S. Cl. 601/15; 601/37

(57) ABSTRACT

An adjustable goggle for eye massagers includes a retaining plate in the center, covers pivotally coupled on two transverse ends of the retaining plate, a strap running through the retaining plate, and ornamental flaps located outside the covers and the strap, and jointly and pivotally coupled with the retaining plate. An electric assembly is anchored on the retaining plate. The adjustable goggle includes a heating pad and/or a massage pad that are located in an area surrounded by the retaining plate and the covers on two sides. The covers and the ornamental flaps may be swiveled about the retaining plate to provide a snug adjustment according to user's face profile. The strap is elastic and may be worn on user's head above the ears to reduce pressure on user's eyes.

### BACKGROUND OF THE INVENTION

1. Field of the Invention

The invention relates to a goggle for eye massagers that have an eye heating pad and/or massaging pad and is adjustable according to user's face feature to provide most comfortable and convenient operation for users.

2. Description of the Prior Art

Eye massager is a device that provides heating and vibration treatments for the tissues around user's eye to give the eye relaxation. Refer to FIG. 1 for a conventional eye massager 1 now available on the market. It includes an electric assembly 10, a massage portion 11 and a band 12. The electric assembly 10 is located in front of the eyes 20 of a user 2 during use. The massage portion 11 is resting on the eyes 20. The band 12 is connected to distal ends of the passage portion 11 and worn on user's head. The eye massager 1 so constructed still has disadvantages when in use, notably:

The electric assembly 10 occupies a great portion of the weight of the eye massager 1. The connected pliable massage portion 11 and the band 12 cannot bear the weight. As a result the weight of the electric assembly 10 concentrates mostly on user's nose 21 to form a heavy and uncomfortable pressure.

In addition, the massage portion 11 cannot bear the weight of the electric assembly 10. The band 12 has to be tightly coupled on user's head to balance the load. The coupling force is levied around the eyes and through the ears 22 to the band 12. This often incurs uncomfortable feeling to user's head. It diminishes the intended massage effect of the eye massager.

Moreover, the electric assembly 10 is a rigid and inflexible box. Even if the massage portion 11 is a pliable part and can rest snugly around user's eyes, the band 12 could run out of elasticity and cannot be worn on user's head securely. The weight of the electric assembly 10 could cause the massage portion 11 partially breaking away from the tissues surrounding the eyes. As a result, the massaging effect is not desirable.

### SUMMARY OF THE INVENTION

In view of the aforesaid problems of the conventional eye massager such as the rigid electric assembly being not bendable to rest on user's face, the coupled pliable massage portion not able to fully support the weight of electric assembly and relying on the band to be worn on user's head tightly, and wearing being uncomfortable and the massaging effect not desirable, the present invention aims to provide a novel goggle for eye massagers that is adjustable according to user's face profile to achieve most comfort and convenient operation. The adjustable goggle mainly includes a retaining plate in the center, an eye cover and an ornamental flap pivotally coupled on each of two sides, and a strap coupled on the retaining plate. The ornamental flap is located outside the cover and strap. By means of aforesaid structure, the electric assembly is anchored on the retaining plate. A heating pad and/or massage pad is located in an area surrounded by the retaining plate and the covers on two sides. The covers and the ornamental flap can swivel about the retaining plate so that they can be adjusted according to user's face profile. The strap is located above user's ears, and has an elastic force to couple on user's head above the ears. Thus it can reduce the pressure on user's eyes. Moreover, the rigid retaining plate, the covers pivotally coupled on two sides and strap can jointly withstand and brace the weight of the electric assembly to prevent the weight concentrating on user's nose or face.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional eye massager worn on a user's head;

FIG. 2 is an exploded view of the invention;

FIG. 3 is a perspective view of the invention;

FIG. 4 is a sectional view of the invention coupled with an electric assembly, a heating pad and a massage pad;

FIG. 5 is a top view of the invention coupled with a strap and a retaining plate;

FIG. 6 is a top view of the invention in use in an adjusting condition; and

FIG. 7 is a schematic view of the invention worn on a user's head.

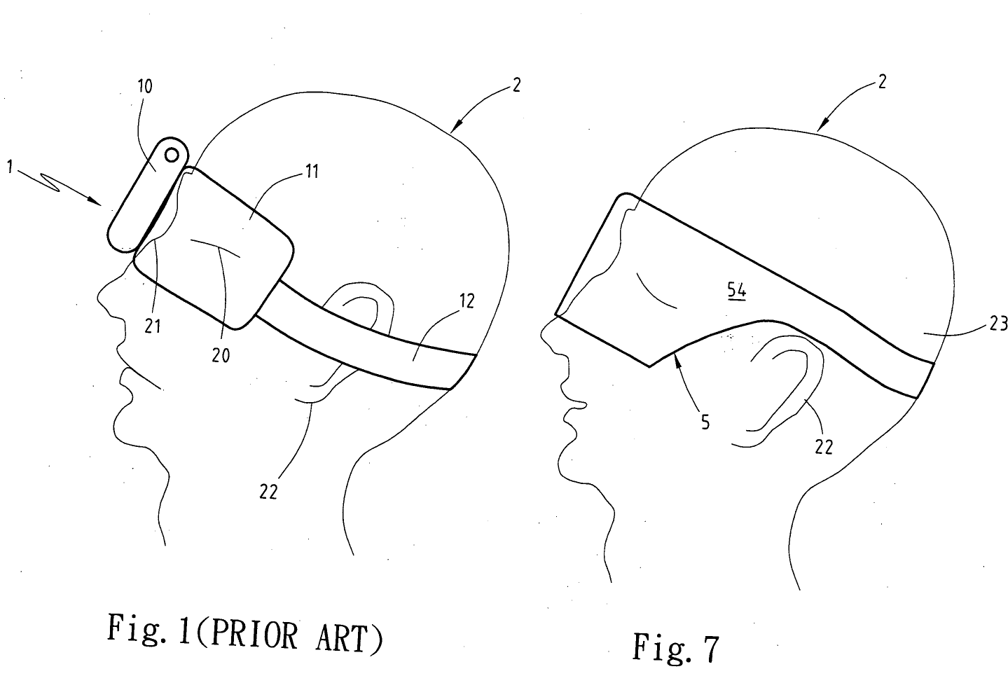

### DESCRIPTION OF THE PREFERRED EMBODIMENTS

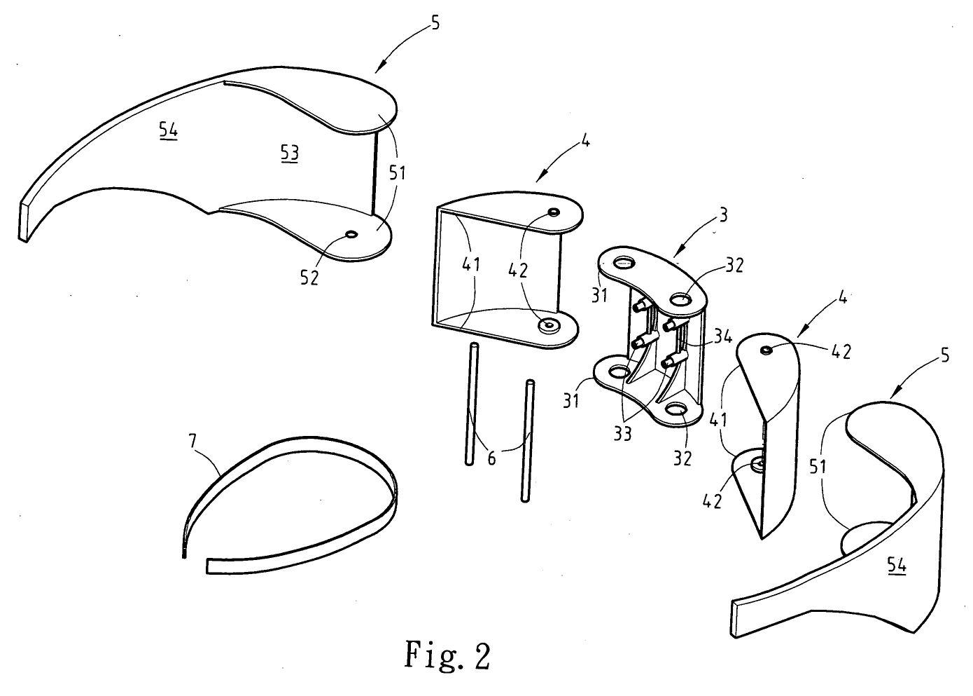

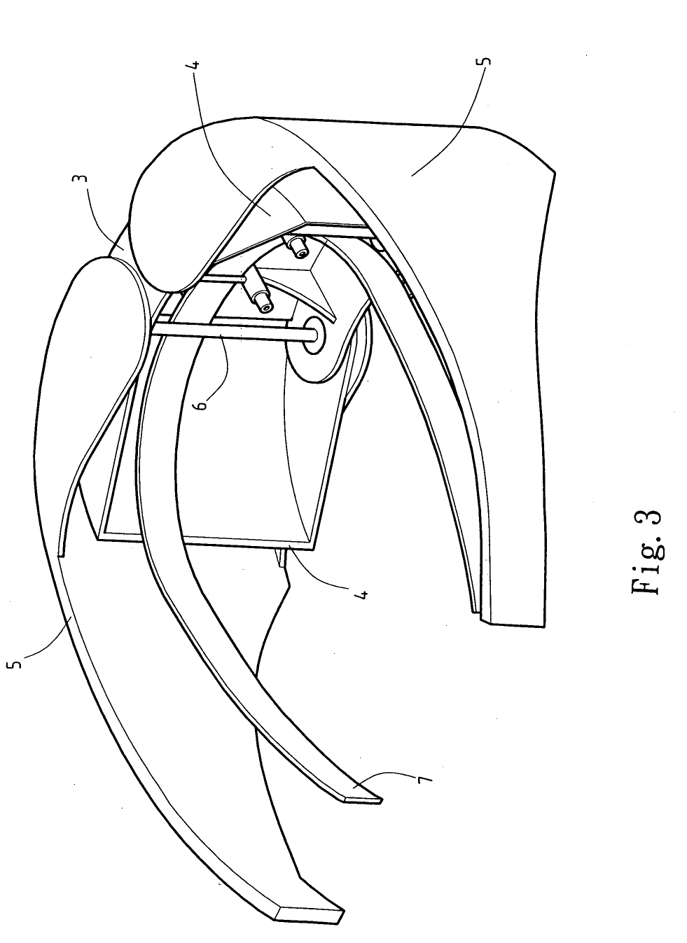

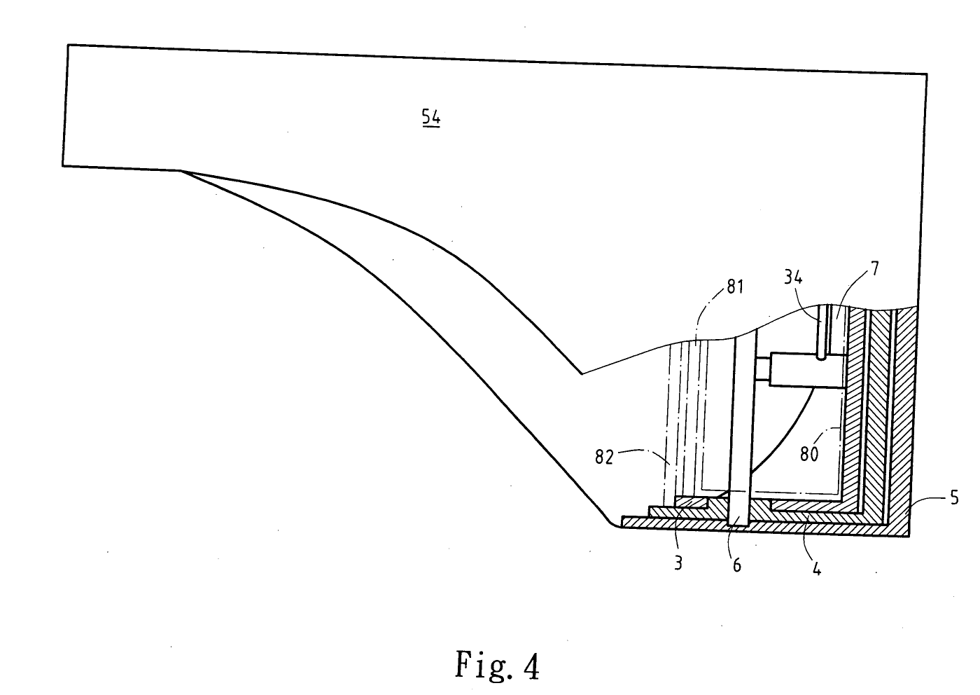

Refer to FIGS. 2, 3 and 4 for an embodiment of the adjustable goggle for eye massagers according to the invention. It includes a retaining plate 3 located in the center of the goggle, and a tongue plate 31 extended respectively to one lateral side from an upper edge and lower edge of the retaining plate. The tongue plate 31 has a pivot hole 32 on a left end and a right end. In this embodiment, there are anchor struts 33 in the center portion of the retaining plate 3 to anchor an electric assembly 80 of the eye massager (referring to FIG. 4). There is also a pair of stopping rods 34 on the back side of the center of the retaining plate 3; two covers 4 pivotally coupled with pivot holes 32 on the left end and right end of the retaining plate 3. In this embodiment, the cover 4 has a first tongue flap 41 extended from a upper end and a lower end of the covers 4 and formed in a shape like a bird wing extending transversely and being wider at one end. However, the shape of the first tongue flap may also be an equal width transversely or other shapes desired. It has a fish eye pivot knob 42 on one end to be pivotally coupled with the retaining plate 3; two ornamental flaps 5 which are pivotally coupled on the pivot holes 32 on two ends of the retaining plate 3. In this embodiment, the ornamental flaps 5 have respectively an extended second tongue flap 51 formed in a shape of a bird wing like the first tongue flap 41. Of course it also may be formed in other shape desired. The second tongue flap 51 has an aperture 52 on one end to be pivotally coupled with the cover 4 through a pin 6 which also runs through the retaining plate 3, cover 4 and ornamental flap 5 to couple them together. The ornamental flap 5 has an upright wall 53 between the two second tongue flaps 51. The upright wall 53 is in front of the cover 4. Moreover, the upright wall 53 has a band 54 whose width shrinks gradually to form a tapered distal end; and a strap 7 which is hard and elastic like a general hair strap.

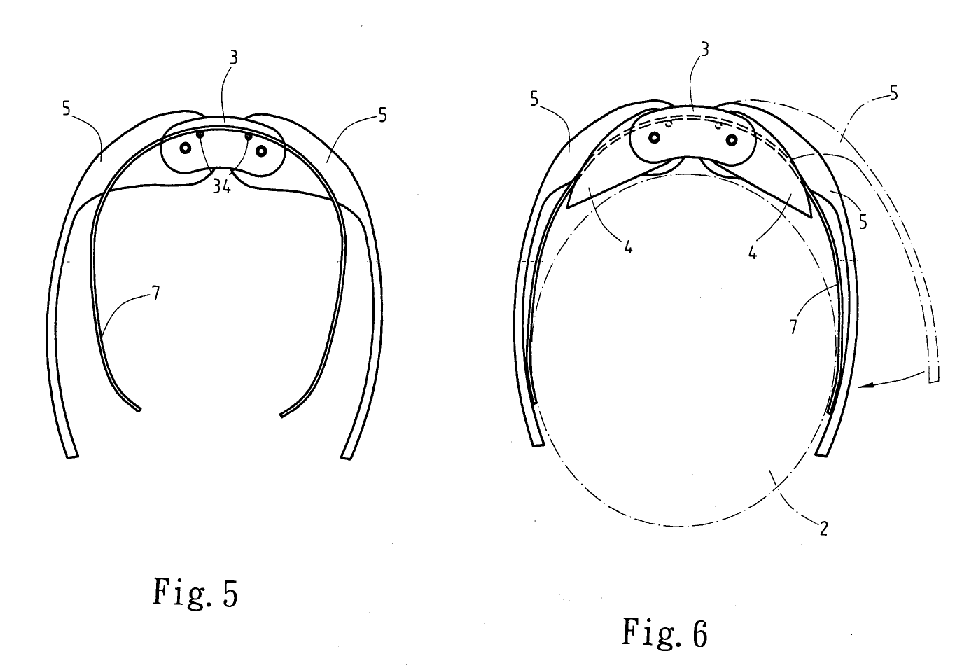

According to the embodiment of the invention, the electric assembly 80 of the eye massager is mounted onto the retaining plate 3. A heating pad 81 and a massage pad 82 are anchored sequentially on the anchor struts 33 as shown in FIG. 5. Hence the electric assembly 80 that cannot deforms is held stationary on the retaining plate 3. The heating pad 81 and the massage pad 82 are coupled on the anchor struts 33 in the center with most portion located in the area surrounded by the cover 4 on two sides. The cover 4 may be swiveled about the retaining plate 3 to adjust the heating pad 81 and the massage pad 82 according to user's face profile to generate a desired massaging effect. In addition, the ornamental flap 5 may also be swiveled independently about the retaining plate 3 to be worn snuggly on user's head as shown in FIG. 6. The strap 7 runs through a rear side of a pair of stopping rods 34 in the center of the retaining plate 3 and is blocked by the stopping rods 34 and coupled with the retaining plate 3. When in use, it is located above user's ears 22, thus does not press the ears 22 as the band 12 of the conventional eye massager does, and can eliminate user's discomfort. Referring to FIG. 7, the strap 7 has elasticity to be coupled on user's head 23 above the ears 22. The covers 4 on the left side and right side, and the ornamental flaps 5 can cover the entire rigid retaining plate 3. Hence the weight of the electric assembly 80 is evenly distributed to other portions of user's head, and can avoid the weight concentrating on user's nose or face, and eliminate uncomfortable pressure.

Referring to FIG. 6, in practice, the tail end of the strap 7 may be partially stitched or bonded to the ornamental flap 5 so that when the strap 7 is expanded according to the size of user's head 2, the ornamental flap 5 also is expanded to the same degree at the same time. In other embodiments, the strap 7 and the ornamental flap 5 may be separated. After the strap 7 is expanded according to user's head 2, the ornamental flap 5 may be swiveled manually to be close to the strap 7.

The ornamental flap 5 set forth above mainly aims to cover and decorate the outer portion of the strap 7. Hence it may be dispensed with in some embodiments. In the previous embodiment in which the strap 7 and the ornamental flap 5 are partially stitched or bonded together, the ornamental flap 5 can aid the strap 7 to be worn securely on user's head.

By means of the adjustable goggle set forth above, the weight of the eye massager can be evenly distributed without concentrating on a specific portion of user's face. Uncomfortable feeling can be eliminated. Moreover, the two covers are independent, and can be adjusted individually to form a snug contact with user to achieve an improved massaging effect.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. An adjustable goggle for eye massagers, comprising:
a retaining plate located in the center of the adjustable goggle having a tongue plate extended respectively to a lateral side from a upper edge and a lower edge thereof, the tongue plate having a pivot hole on a left end and a right end;
two covers pivotally coupled 'with the pivot holes on two ends of the retaining plate;
two ornamental flaps covering a front side of the covers, and being pivotally coupled with the pivot holes on two ends of the retaining plate; and
an elastic strap running through a rear side of a pair of stopping rods located on a back side in the center of the retaining plate.

2. The adjustable goggle for eye massagers of claim 1, wherein the retaining plate, the covers, and the ornamental flaps are pivotally coupled together through a pin.

3. The adjustable goggle for eye massagers of claim 1, wherein the covers and the ornamental flaps are swivelable independently about an axis thereof.

4. The adjustable goggle for eye massagers of claim 1, wherein the tongue plates extended from the upper edge and the lower edge of the retaining plate form a space therebetween to hold an electric assembly of an eye massager.

5. The adjustable goggle for eye massagers of claim 1, wherein the ornamental flap has a band which is extended from the pivot end to another end which is open and has a width shrinking gradually to the open end.

6. An adjustable goggle for eye massagers, comprising:
a retaining plate located in the center of the adjustable goggle having a tongue plate extended respectively to a lateral side from a upper edge and a lower edge thereof, the tongue plate having a pivot hole on a left end and a right end;
two covers pivotally coupled with the pivot holes on two ends of the retaining plate; and
an elastic strap running through a rear side of a pair of stopping rods located on a back side in the center of the retaining plate.
